(19) United States
(12) Patent Application Publication
(10) Pub. No.: US 2010/0283789 A1
(43) Pub. Date: Nov. 11, 2010

(54) DISPLAY APPARATUS HAVING A PLURALITY OF CONTROLLERS AND VIDEO DATA PROCESSING METHOD THEREOF

(76) Inventors: Yao-Hung Lai, Tainan County (TW); Yung-Yuan Ho, Tainan County (TW); Yen-Chen Chen, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/464,091

(22) Filed: May 11, 2009

(51) Int. Cl. G06F 15/16

(52) U.S. Cl. 345/502

(57) ABSTRACT

A display apparatus includes a first controller, a second controller and a display panel. The first controller includes a first memory and is used for receiving a first portion of pixel data of a frame and storing the first portion of the pixel data into the first memory. The second controller, which is external to the first controller and includes a second memory, is used for receiving a second portion of the pixel data of the frame and storing the second portion of the pixel data into the second memory. The display panel is used for receiving at least the first and the second portion of the pixel data outputted from the first and the second controllers, respectively.

### BACKGROUND OF THE INVENTION

1. Field of the Invention

The present invention relates to a display apparatus, and more particularly, to a display apparatus having a plurality of controllers, and a video data processing method thereof.

2. Description of the Prior Art

Please refer to FIG. 1. FIG. 1 is a conventional display apparatus 100. The display apparatus 100 includes a controller 110 and display panel, where the controller 110 includes a frame memory 112 and an output buffer 114. In the operations of the display apparatus 100, the controller 110 receives video data (including control signal and pixel data) and stores the pixel data into the frame memory. After that, the controller 110 executes image processing such as scaling upon the pixel data. Then, the pixel data are transmitted from the frame memory 112 to the display panel 120 via the output buffer 114.

The frame memory 112 is used to store the pixel data of a frame or other video data, therefore a size of the frame memory 112 must be large enough to store these data. For example, when a resolution of the display apparatus 100 is 640*480 (that is, a frame has 640*480 pixel data), the size of the frame memory 112 must be large enough to store 640*480 pixel data as well as other video data. Therefore, the controller has backward compatibility but does not have forward compatibility. That is, the controller 110 designed for a display apparatus with a resolution of 640*480 can be used in a display apparatus with a resolution of 320*240, but cannot be used in a display apparatus with a resolution of 1024*728 due to the insufficient capacity of the frame memory 112.

In addition, although the controller 110 designed for a display apparatus with a resolution of 640*480 can be used in a display apparatus with a resolution of 320*240, a large portion of the frame memory 112 is wasted. Therefore, the controller 110 needs to be re-designed for each resolution, meaning manufacturing costs are correspondingly increased.

### SUMMARY OF THE INVENTION

It is an objective of the present invention to provide a display apparatus having a plurality of controllers, which has forward compatibility and is therefore able to save manufacturing costs, in order to solve the above-mentioned problems.

According to one embodiment of the present invention, a display apparatus comprises a first controller, a second controller and a display panel. The first controller includes a first memory and is used for receiving a first portion of pixel data of a frame and storing the first portion of the pixel data into the first memory. The second controller, which is external to the first controller and includes a second memory, is used for receiving a second portion of the pixel data of the frame and storing the second portion of the pixel data into the second memory. The display panel is used for receiving at least the first and the second portion of the pixel data outputted from the first and the second controllers, respectively.

According to another embodiment of the present invention, a video data processing method comprises: receiving a first portion of pixel data of a frame and storing the first portion of the pixel data into a first memory of a first controller; receiving a second portion of the pixel data of the frame and storing the second portion of the pixel data into a second memory of a second controller; and transmitting at least the first and the second portion of the pixel data from the first and the second controllers to a display panel, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a conventional display apparatus.

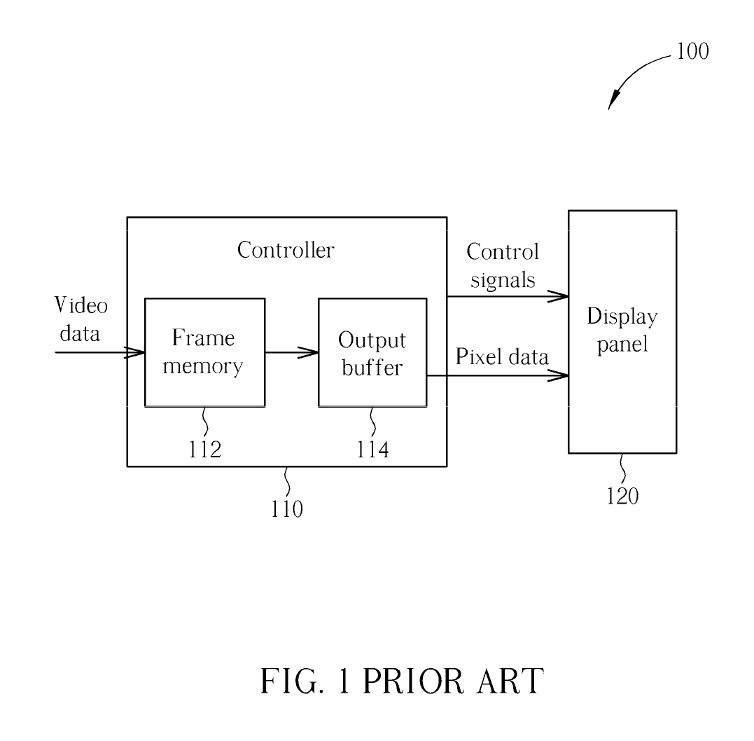

FIG. 2 is a diagram illustrating a display apparatus according to one embodiment of the present invention.

FIG. 3 is a diagram illustrating a frame.

FIG. 4 is a diagram illustrating a display apparatus according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

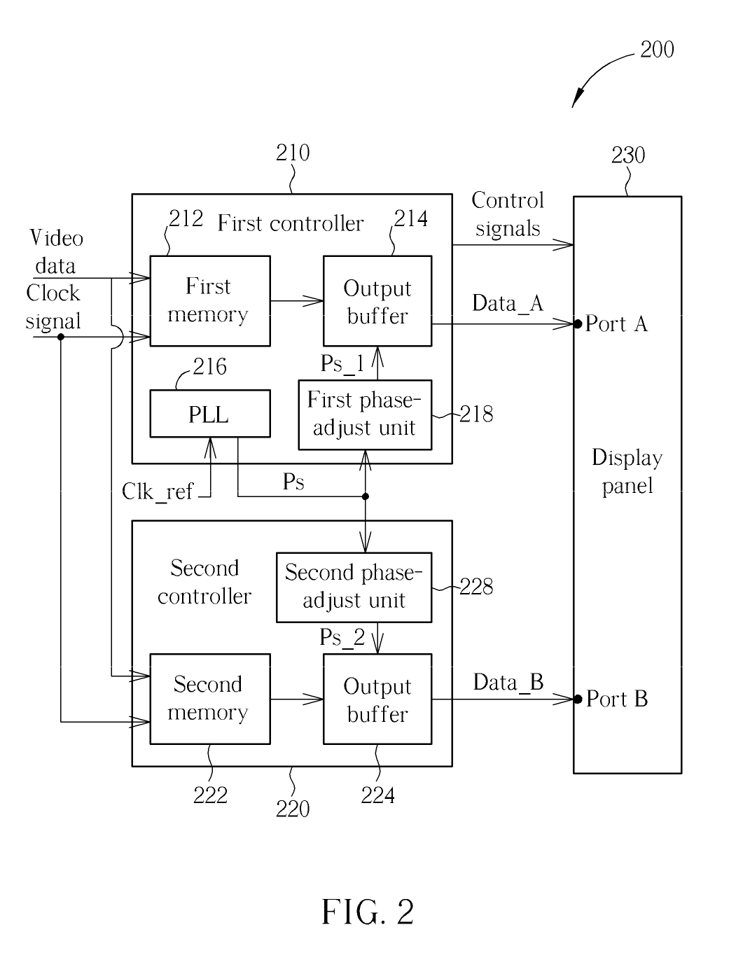

Please refer to FIG. 2. FIG. 2 is a diagram illustrating a display apparatus 200 according to one embodiment of the present invention. The display apparatus 200 includes a first controller 210, a second controller 220 and a display panel 230, where the first controller 210 includes a first memory 212, an output buffer 214, a phase-locked loop (PLL) 216 and a first phase-adjust unit 218, and the second controller 220 includes a second memory 222, an output buffer 224 and a second phase-adjust unit 228. In addition, the display panel 230 has a first port Port_A coupled to the first controller 210, and a second port Port_B coupled to the second controller 220. In addition, the first controller 210 and the second controller 220 are built in different chips.

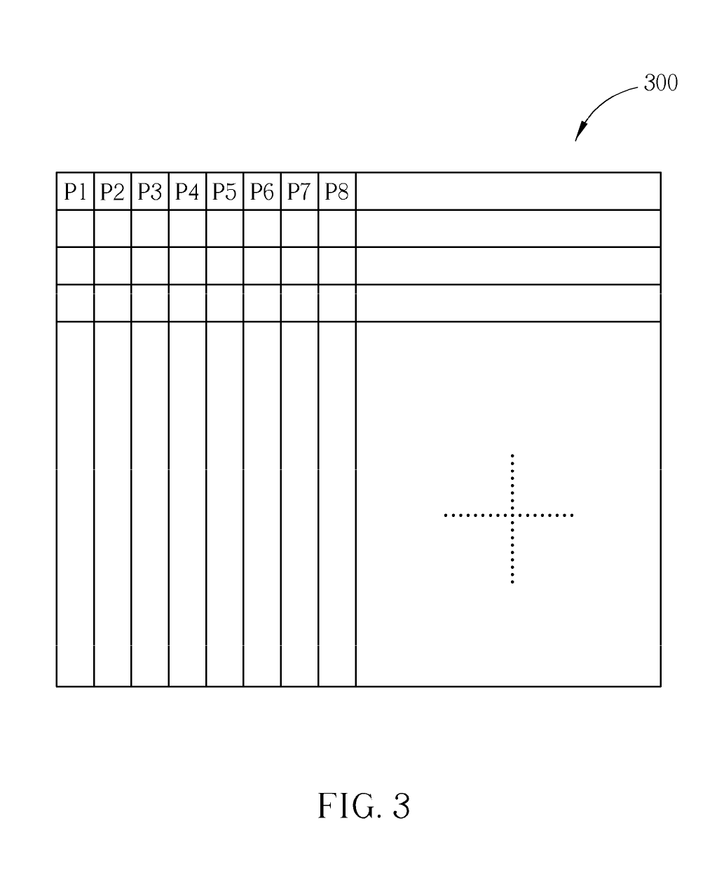

In the operations of the display apparatus 200, the first controller 210 receives a clock signal, a first portion of pixel data, a vertical synchronous signal Vsync and a horizontal synchronous signal Hsync (video data shown in FIG. 2 includes pixel data of a frame, the vertical synchronous signal Vsync and the horizontal synchronous signal Hsync) and stores at least the first portion of the pixel data into the first memory 212. The second controller 220 receives the clock signal, a second portion of the pixel data and stores at least the second portion of the pixel data into the second memory 222. In addition, in this embodiment, the first and second portions of the pixel data first include half of the pixel data of the frame, respectively, and more particularly, the first portion of the pixel data includes all odd pixel data of the frame, and the second portion of the pixel data includes all even pixel data of the frame. Taking a frame 300 shown in FIG. 3 as an example, odd pixel data p1, p3, p5, . . . etc. are stored into the first memory 212, and even pixel data p2, p4, . . . etc. are stored into the second memory 222.

Then, the first portion of the pixel data of the frame are sequentially transmitted to the output buffer 214 (i.e., the pixel data p1, p3, p5, . . . etc.), and the second portion of the pixel data of the frame are sequentially transmitted to the output buffer 224 (i.e., the pixel data p2, p4, . . . etc.). At the same time, the PLL 216 receives a reference clock Clk_ref to generate a synchronous signal Ps, and the first phase-adjust unit 218 phase-adjusts the synchronous signal to generate a first phase-adjusted synchronous signal Ps_1, and the second phase-adjust unit 228 phase-adjusts the synchronous signal to generate a second phase-adjusted synchronous signal Ps_2. The first and second phase-adjusted synchronous signals Ps_1 and Ps_2 are used to trigger the output buffers 214 and 224, respectively, to make the output buffers 214 and 224 synchronously output the first and the second portions of the pixel data to the display panel 230 (Data_A and Data_B shown in FIG. 2 are the first and the second portions of the pixel data, respectively). For example, referring to FIG. 3, the pixel data p1 (temporally stored in the output buffer 214) and the pixel data p2 (temporally stored in the output buffer 224) are synchronously transmitted to the display panel 230 via the ports Port_A and Port_B, respectively. In a next operation, the pixel data p3 (temporally stored in the output buffer 214) and the pixel data p4 (temporally stored in the output buffer 224) are synchronously transmitted to the display panel 230 via the ports Port_A and Port_B, respectively, etc. In addition, the first controller 210 also transmits control signals which includes at least a data enable signal and another clock signal to the display panel 230.

It is noted that the first and second phase-adjust units 218 and 228 are used to phase-adjust the synchronous signal Ps to generate the first and second phase-adjusted synchronous signals Ps_1 and Ps_2, in order to make the first and the second output buffers synchronously output the first and the second portion of the pixel data to the display panel 230. That is, the first and second phase-adjust units 218 and 228 are used to make the first and second phase-adjusted synchronous signals Ps_1 and Ps_2 phase-match. If positions of the first controller 210 and the second controller 220 are close, however, the phase of the synchronous signal Ps received by the first controller 210 may be largely similar to the phase of the synchronous signal Ps received by the second controller 210. Therefore, the first and second phase-adjust units 218 and 228 are not required and can be removed without influencing the functions of the display apparatus 200, and the synchronous signal Ps is used to trigger the output buffers 214 and 224 to synchronously output the first and second portions of the pixel data to the display panel 230.

One advantage of the display apparatus 200 is as follows: assuming a resolution of the display apparatus 200 is 640*480 (VGA), a size of the first memory 212 of the first controller 210 can be designed to be capable of storing 640*240 pixel data, and a size of the second memory 222 of the second controller 220 can also be designed to be capable of storing 640*240 pixel data. Therefore, the first controller 210 can be independently used in a display apparatus with a resolution of 320*240 (QVGA) because the capacity of the first memory 212 is large enough for storing the pixel data of a frame in the display apparatus with the resolution of 320*240. That is, there is no need to re-design a controller for the display apparatus with a resolution of 320*240, and memory space is not wasted.

Another advantage is that, if a controller of a display apparatus with a resolution of 320*240 has been designed and the controller of the display apparatus with the resolution of 320*240 is capable of storing 640*240 pixel data, the controller display apparatus with the resolution of 320*240 can be further used in a display apparatus with a greater resolution. For example, assuming the resolution of the display apparatus 200 is 640*480, the first controller 210 does not need to be designed and can directly use the controller which is originally used in the display apparatus with the resolution of 320*240. That is, because the first controller 210 has been designed for the display apparatus with the resolution of 320*240, only the controller 220 needs to be provided (design of the second controller 220 is much easier than that of the first controller 210), and design of the display apparatus 200 is therefore simplified.

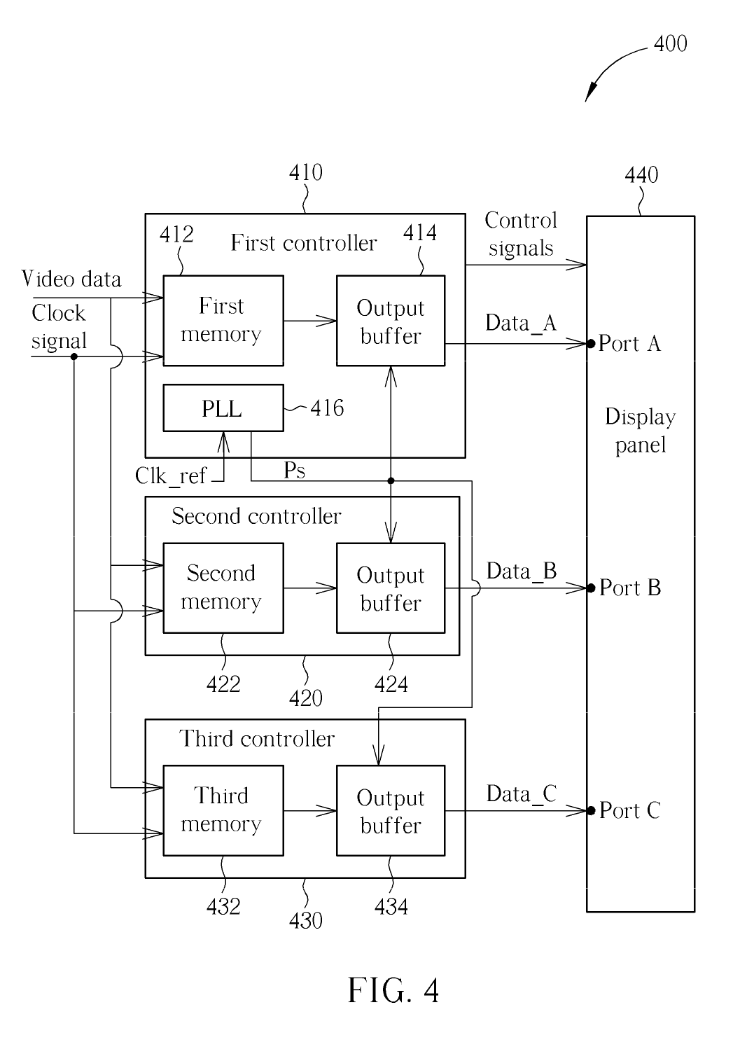

Please refer to FIG. 4. FIG. 4 is a diagram illustrating a display apparatus 400 according to another embodiment of the present invention. The display apparatus 400 includes a first controller 410, a second controller 420, a third controller 430 and a display panel 440, where the first controller 410 includes a first memory 412, an output buffer 414 and a phase-locked loop (PLL) 416, the second controller 420 includes a second memory 422 and an output buffer 424, and the third controller 430 includes a third memory 432 and an output buffer 434. In addition, the display panel 440 has a first port Port_A coupled to the first controller 410, a second port Port_B coupled to the second controller 420, and a third port Port_C coupled to the third controller 430. In addition, the first, second and third controllers 410, 420 and 430 are built in different chips.

In the operations of the display apparatus 400, the first controller 410 receives a clock signal, a first portion of pixel data, a vertical synchronous signal Vsync and a horizontal synchronous signal Hsync (video data includes pixel data of a frame, the vertical synchronous signal Vsync and the horizontal synchronous signal Hsync) and stores at least the first portion of the pixel data into the first memory 412. The second controller 420 receives the clock signal, a second portion of the pixel data and stores at least the second portion of the pixel data into the second memory 422. The third controller 430 receives the clock signal, a third portion of the pixel data and stores at least the third portion of the pixel data into the third memory 432. In addition, in this embodiment, the first, second and third portions of the pixel data include one-third of the pixel data of the frame, respectively, and more particularly, taking the frame 300 shown in FIG. 3 as an example, the first portion of the pixel data is p1, p4, p7, . . . , etc., the second portion of the pixel data is p2, p5, p8, . . . , etc., and the third portion of the pixel data is p3, p6, . . . , etc.

Then, the first portion of the pixel data of the frame are sequentially transmitted to the output buffer 414 (i.e., the pixel data p1, p4, p7, . . . etc.), the second portion of the pixel data of the frame are sequentially transmitted to the output buffer 424 (i.e., the pixel data p2, p5, p8, . . . etc.), and the third portion of the pixel data of the frame are sequentially transmitted to the output buffer 434 (i.e., the pixel data p3, p6, . . . etc.). At the same time, the PLL 416 receives a reference clock Clk_ref to generate a synchronous signal Ps. The synchronous signal Ps is used to trigger the output buffers 414, 424 and 434, to make the output buffers 414, 424 and 434 synchronously output the first, second and third portions of the pixel data to the display panel 440, respectively (Data_A, Data_B and Data_C shown in FIG. 4 are the first, second and third portions of the pixel data, respectively). For example, referring to FIG. 3, the pixel data p1 (temporally stored in the output buffer 414), the pixel data p2 (temporally stored in the output buffer 424), and the pixel data p3 (temporally stored in the output buffer 434) are synchronously transmitted to the display panel 440 via the ports Port_A, Port_B and Port_C, respectively. At a next operation, the pixel data p4 (temporally stored in the output buffer 414), the pixel data p5 (temporally stored in the output buffer 424), and the pixel data p6 (temporally stored in the output buffer 434) are synchronously transmitted to the display panel 440 via the ports Port_A, Port_B and Port_C, respectively, etc. In addition, the first controller 410 also transmits control signals which includes at least a data enable signal and another clock signal to the display panel 440.

It is noted that the phase-adjust units shown in FIG. 2 can be added to each of the controllers 410, 420 and 430 of the display apparatus 400 shown in FIG. 4 to enable the output buffers 414, 424 and 434 to more synchronously output the data to the display panel 440. A person skilled in this art should understand the detailed operations of the phase-adjust units added to the display apparatus 400 after reading the above-mentioned descriptions regarding the phase-adjust units 218 and 228, therefore further descriptions are omitted here.

In addition, the display apparatuses 200 and 400 can be color-sequential LCOS (Liquid Crystal on Silicon) display apparatuses, and the display panels 230 and 440 are color-sequential LCOS display panels.

Briefly summarized, the display apparatus of the present invention has a plurality of controllers, and each controller is used for receiving a portion of pixel data of a frame and storing the portion of the pixel data into its memory. Then, the pixel data stored in the memories are synchronously transmitted to a display panel. The display apparatus of the present invention can simplify the design of the controller, and manufacture cost is therefore decreased.

Those skilled in the art will readily observe that numerous modifications and alterations of the device and method may be made while retaining the teachings of the invention.

What is claimed is:

1. A display apparatus, comprising:
a first controller comprising a first memory, for receiving a first portion of pixel data of a frame and storing the first portion of the pixel data into the first memory;
a second controller, external to the first controller and comprising a second memory, for receiving a second portion of the pixel data of the frame and storing the second portion of the pixel data into the second memory; and
a display panel, coupled to the first and the second controllers, for receiving at least the first and the second portions of the pixel data outputted from the first and the second controllers, respectively.

2. The display apparatus of claim 1, wherein the display panel has a first port coupled to the first controller for receiving the first portion of the pixel data outputted from the first controller, and a second port coupled to the second controller for receiving the second portion of the pixel data outputted from the second controller; and the first and the second controllers synchronously output the first and the second portions of the pixel data to the display panel.

3. The display apparatus of claim 2, wherein the first controller comprises:
a phase-locked loop, for receiving a reference clock to generate a synchronous signal, wherein the first and the second controllers synchronously output the first and the second portions of the pixel data to the display panel according to the synchronous signal.

4. The display apparatus of claim 3, wherein the first controller comprises a first phase-adjust unit and a first buffer, the second controller comprises a second phase-adjust unit and a second buffer, the first memory sequentially transmits the first portion of pixel data to the first buffer, the second memory sequentially transmits the second portion of pixel data to the second buffer, the first phase-adjust unit receives the synchronous signal to generate a first phase-adjusted synchronous signal, the second phase-adjust unit receives the synchronous signal to generate a second phase-adjusted synchronous signal, and the first and the second output buffers synchronously output the first and the second portions of the pixel data to the display panel according to the first and second phase-adjusted synchronous signals, respectively.

5. The display apparatus of claim 1, wherein the first and the second portions of the pixel data each include half of the pixel data of the frame.

6. The display apparatus of claim 5, wherein the first portion of the pixel data includes all odd pixel data of the frame, and the second portion of the pixel data includes all even pixel data of the frame.

7. The display apparatus of claim 1, wherein the first controller and the second controller are built in different chips.

8. The display apparatus of claim 1, further comprising:
a third controller, external to the first and second controllers and comprising a third memory, for receiving a third portion of the pixel data of the frame and storing the third portion of the pixel data into the third memory;
wherein the display panel is further coupled to the third controller, and further receives the third portion of the pixel data outputted from the third controller.

9. The display apparatus of claim 8, wherein the display panel has a first port coupled to the first controller for receiving the first portion of the pixel data outputted from the first controller, and a second port coupled to the second controller for receiving the second portion of the pixel data outputted from the second controller, and a third port coupled to the third controller for receiving the third portion of the pixel data outputted from the third controller; and the first, the second and the third controllers synchronously output the first, the second and the third portions of the pixel data to the display panel.

10. The display apparatus of claim 9, wherein the first controller comprises:
a phase-locked loop, for receiving a reference clock to generate a synchronous signal, and the first, the second and the third controllers synchronously output the first, the second and the third portions of the pixel data to the display panel according to the synchronous signal.

11. The display apparatus of claim 10, wherein the first controller comprises a first buffer, the second controller comprises a second buffer, and the third controller comprises a third buffer, the first portion of pixel data are sequentially transmitted from the first memory to the first buffer, the second portion of pixel data are sequentially transmitted from the second memory to the second buffer, the third portion of pixel data are sequentially transmitted from the third memory to the third buffer, and the first, the second and the third buffers synchronously output the first, the second and the third portions of the pixel data to the display panel according to the synchronous signal.

12. The display apparatus of claim 8, wherein the first, the second and the third portions of the pixel data each include one-third of the pixel data of the frame.

13. The display apparatus of claim 8, wherein the first controller, the second controller, and the third controller are built in different respective chips.

14. A video data processing method, comprising:
receiving a first portion of pixel data of a frame and storing the first portion of the pixel data into a first memory of a first controller;
receiving a second portion of the pixel data of the frame and storing the second portion of the pixel data into a second memory of a second controller; and
transmitting at least the first and the second portions of the pixel data from the first and the second controllers to a display panel, respectively.

15. The video data processing method of claim 14, wherein the step of transmitting at least the first and the second portions of the pixel data from the first and the second controllers to the display panel comprises:
synchronously transmitting at least the first and the second portions of the pixel data from the first and the second controllers to the display panel.

16. The video data processing method of claim 15, further comprising:
receiving a reference clock to generate a synchronous signal; and
the step of synchronously transmitting at least the first and the second portions of the pixel data from the first and the second controllers to the display panel comprises:
synchronously transmitting at least the first and the second portions of the pixel data from the first and the second controllers to the display panel according to the synchronous signal.

17. The video data processing method of claim 16, further comprising:
sequentially transmitting the first portion of pixel data from the first memory to a first buffer of the first controller;
sequentially transmitting the second portion of pixel data from the second memory to a second buffer of the second controller;
phase-adjusting the synchronous signal to generate a first phase-adjusted synchronous signal;
phase-adjusting the synchronous signal to generate a second phase-adjusted synchronous signal; and
the step of synchronously transmitting at least the first and the second portions of the pixel data from the first and the second controllers to the display panel comprises:
synchronously transmitting at least the first and the second portions of the pixel data from the first and the second buffers to the display panel according to the first and second phase-adjusted synchronous signal, respectively.

18. The video data processing method of claim 14, wherein the first and the second portions of the pixel data each include half of the pixel data of the frame.

19. The video data processing method of claim 18, wherein the first portion of the pixel data includes all odd pixel data of the frame, and the second portion of the pixel data includes all even pixel data of the frame.

20. The video data processing method of claim 14, wherein the first controller and the second controller are built in different chips.
